(19) United States
(12) Patent Application Publication
(10) Pub. No.: US 2018/0165770 A1
(43) Pub. Date: Jun. 14, 2018

(54) PROVIDING TARGETED CONTENT

(71) Applicant: MeadCon LLC, Kirkland, WA (US)

(72) Inventor: Eric Mead, Kirkland, WA (US)

(21) Appl. No.: 15/374,089

(22) Filed: Dec. 9, 2016

(51) Int. Cl. G06Q 50/00; G06N 99/00

(52) U.S. Cl. CPC G06Q 50/01; G06N 99/005

(57) ABSTRACT

An apparatus for providing targeted content to a reference subscribing account includes a processor, having a transcription module to transcribe subscriber content uploaded from the subscribing account, a scoring module to assign an accuracy score to the transcribed subscriber content for accuracy based on predetermined accuracy metrics, and store, to a learning database, the transcribed subscriber content when the assigned accuracy score at least equals a predetermined accuracy threshold score. The processor further includes a parsing module to extract and parse the stored subscriber content from the learning database based on one or more content attributes, and a prioritizing module to prioritize one or more subscriber contents uploaded from one or more subscribing accounts to be provided as targeted content. The apparatus further includes a user interface to provide the prioritized targeted content to the reference subscribing account.

### TECHNICAL FIELD

The embodiments described herein pertain generally to providing targeted content to a user account and an application program product to facilitate the providing targeted content to a user account.

### BACKGROUND

Sharing memories on social media is becoming more and more common. Many of the memories shared on a social network relate to the places travelled, experiences related to those places, and foods enjoyed in those places and/or with specific people.

### SUMMARY

In one example embodiment, an apparatus for providing targeted content to a reference subscribing account includes a processor, having a transcription module to transcribe subscriber content uploaded from the reference subscribing account, a scoring module to assign an accuracy score to the transcribed subscriber content for accuracy based on predetermined accuracy metrics, and store, to a learning database, the transcribed subscriber content when the assigned accuracy score at least equals a predetermined accuracy threshold score. The processor further includes a parsing module to extract and parse the stored subscriber content from the learning database based on one or more content attributes, and a prioritizing module to prioritize one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof. The apparatus further includes a user interface to provide the prioritized targeted content to the reference subscribing account.

In another example embodiment, a computer-implemented method for providing targeted content to a reference subscribing account includes transcribing the subscriber content uploaded from the reference subscribing account, assigning an accuracy score to the transcribed subscriber content for accuracy based on predetermined accuracy metrics, storing the subscriber content to a learning database when the assigned accuracy score at least equals a predetermined accuracy threshold score. The method further includes extracting and parsing the stored subscriber content from the learning database based on one or more content attributes, prioritizing one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof; and providing the targeted content in the order of priority to the reference subscribing account.

In yet another example embodiment, a computer-readable medium stores instructions that, when executed, cause one or more processor corresponding to an apparatus having a learning database and a user interface to perform operations including transcribing subscriber content uploaded from a reference subscribing account, assigning an accuracy score to the transcribed subscriber content for accuracy based on predetermined accuracy metrics and storing the subscriber content to the learning database when the assigned accuracy score at least equals a predetermined accuracy threshold score. The operations further include extracting and parsing the stored subscriber content from the learning database based on one or more content attributes, prioritizing one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof; and providing the targeted content in the order of priority to the reference subscribing account.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system overview in which one or more embodiments of providing targeted content to a reference subscribing account may be implemented;

FIG. 2 shows an example processing flow of operations for implementing at least portions of providing targeted content to a reference subscribing account in accordance with various embodiments described herein;

FIG. 3 shows an example processing flow of operations for implementing at least portions of providing targeted content to a reference subscribing account in accordance with various embodiments described herein;

FIG. 4 shows an example configuration of a database utilized for providing targeted content to a reference subscribing account in accordance with various embodiments described herein;

FIG. 5 shows another example configuration of a database by which at least portions of providing targeted content to a reference subscribing account may be implemented in accordance with various embodiments described herein;

FIG. 6 shows an example configuration of a content quality score table by which at least portions of providing targeted content to a reference subscribing account may be implemented in accordance with various embodiments described herein;

FIG. 7 shows an example configuration of a prediction engine by which at least portions of providing targeted content to a reference subscribing account may be implemented in accordance with various embodiments described herein;

FIG. 8 shows an example configuration of a prioritization module or a recommendation engine by which at least portions of providing targeted content to a reference subscribing account may be implemented in accordance with various embodiments described herein;

FIG. 9 shows an example computing device for executing instructions by which at least part of various embodiments of providing targeted content to a reference subscribing account may be implemented in accordance with various embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The ubiquity of smartphones and availability of mobile applications hosted or running thereon, including still camera and video camera capabilities, along with readily available internet connectivity has given rise to instantaneous sharing of memories and experiences on social media and/or with a defined sub-set of friends, relatives, colleagues, acquaintances, etc. The memories and/or experiences may be shared in the form of text, pictures, videos, audio clips, etc., each captured and/or taken with friends, relatives, colleagues, acquaintances, etc., using one or more of the above-referenced mobile applications hosted on a user's mobile device or a server-hosted application that the user accesses via a UI on the mobile device. Many of these memories may relate to places travelled, experiences related to those places including products seen or purchased, and foods enjoyed. Having shared one or more of the aforementioned memories, a person may want to recreate those experiences back home, recommend products to others or rate products they have purchased or purchase a product they have seen somewhere and shared as a memory online. And although the person may not remember the recipe of the food eaten, the exact name of the product or the brand, or the name of the experience, etc., the person may remember facets associated with the shared memory, e.g., a peculiar logo, place, shape, or in case of food items a peculiar smell, texture, method of preparation or a particular utensil used to prepare that food. Food memories may also relate to foods prepared by family members that have a special place in peoples' lives, so much so that many foods are known in the family with affectionate names such as “grandma's pie” or “auntie's pudding.”

When the shared memories have not been cataloged or are never given a specific designation, recalling, retrieving and/or extracting these memories based on different characteristics or features may prove challenging. Thus, according to the implementations described herein, for example, in the case of memories related to food, the shared memories may be recalled, retrieved, and/or extracted based on, e.g., a name of a family member that prepared a particular food, a description associated with a peculiar smell of the food, a description of the texture of at least a portion of the food, a method of preparation or a particular utensil used to prepare at least a portion of a particular food etc.

Described herein are example embodiments of a system, apparatus, method, and a computer program product corresponding to a localized or network service for providing targeted content, corresponding to subscriber input, e.g., a shared memory, to the subscriber. The targeted content may relate to a memory that a service subscriber has shared online, via text, pictures, videos, audio clips, etc.; though the provided content itself may have been uploaded by a consumer subscriber, for example, an experience or memory shared by a subscriber, or by other product or service providing subscribers, for example, an advertisement uploaded to a related product or service.

However, memories shared online, as referenced above, provide only partial context for providing targeted content in accordance with the embodiments described herein. Thus, the embodiments pertain to providing targeted content to a subscriber, e.g., a subscriber's account, based on characteristics and/or attributes of a subject of the targeted content. That is, the subject can be identified and the corresponding content can be sent, i.e., targeted, to the requesting subscriber's account, without the subject being named but rather based on characteristics and/or attributes of the subject being provided.

As referenced herein, “content attributes” may refer to characteristics and/or attributes that a subscriber to the content services associates with a subject. As used in the example context of shared online memories (i.e., the content), content attributes may include, but is in no way limited to, name of a relative of a subscriber, a name of a food item, an emotion or sentiment that a subscriber associates with the food item, a recipe for the food item, a name of an ingredient used for preparing the food item, a name of a location from where the food item originated, a name of a location at which the food item was encountered, a time of the day that the subscriber associates with the food item, a day of the week that the subscriber associates with the food item, a year that the subscriber associates with the food item, a month in that the subscriber associates with the food item, any combination thereof.

As further referenced herein, “targeted content” may refer to content that a subscriber has shared online, via text, pictures, videos, audio clips or an advertisement that a subscriber may like to push to other subscribers, e.g. consumer subscribers, via text, pictures, videos, audio clips. The “targeted content” may also refer to a “subscriber content” to be provided to a reference subscribing account based on various parameters as described throughout this application.

Described herein is an exemplary embodiment of an apparatus for providing targeted content to a reference subscribing account that includes a processor, having a transcription module to transcribe subscriber content uploaded from the reference subscribing account, a scoring module to assign an accuracy score to the transcribed subscriber content for accuracy based on predetermined accuracy metrics, and store, to a learning database, the transcribed subscriber content when the assigned accuracy score at least equals a predetermined accuracy threshold score. The processor further includes a parsing module to extract and parse the stored subscriber content from the learning database based on one or more content attributes, and a prioritizing module to prioritize one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof. The apparatus further includes a user interface to provide the prioritized targeted content to the reference subscribing account.

In another example embodiment, computer-implemented method for providing targeted content to a reference subscribing account includes transcribing the subscriber content uploaded from the reference subscribing account, assigning an accuracy score to the transcribed subscriber content for accuracy based on predetermined accuracy metrics, storing the subscriber content to a learning database when the assigned accuracy score at least equals a predetermined accuracy threshold score. The method further includes extracting and parsing the stored subscriber content from the learning database based on one or more content attributes, prioritizing one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof; and providing the targeted content in the order of priority to the subscribing account.

In yet another example embodiment, a computer-readable medium stores instructions that, when executed, cause one or more processors corresponding to an apparatus having a learning database and a user interface to perform operations including transcribing subscriber content uploaded from a reference subscribing account; assigning an accuracy score to the transcribed subscriber content for accuracy based on predetermined accuracy metrics and storing the subscriber content to the learning database when the assigned accuracy score at least equals a predetermined accuracy threshold score. The operations further include extracting and parsing the stored subscriber content from the learning database based on one or more content attributes, prioritizing one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof; and providing the targeted content in the order of priority to the reference subscribing account.

The embodiments described herein including an apparatus and method to provide targeted content to a subscribing account enhance user experience based on what was presented in a subscriber uploaded content within a reasonable timeframe.

Although, embodiments described here are depicted and described as related to food memories, the apparatus and method described herein can also be used to recall content pertaining to other fields, e.g., consumer goods, providers of experiences, that use data in the form of audio, visual or a combination of audio-visual content, sorting and storing such data and providing that data to a user in a user friendly manner.

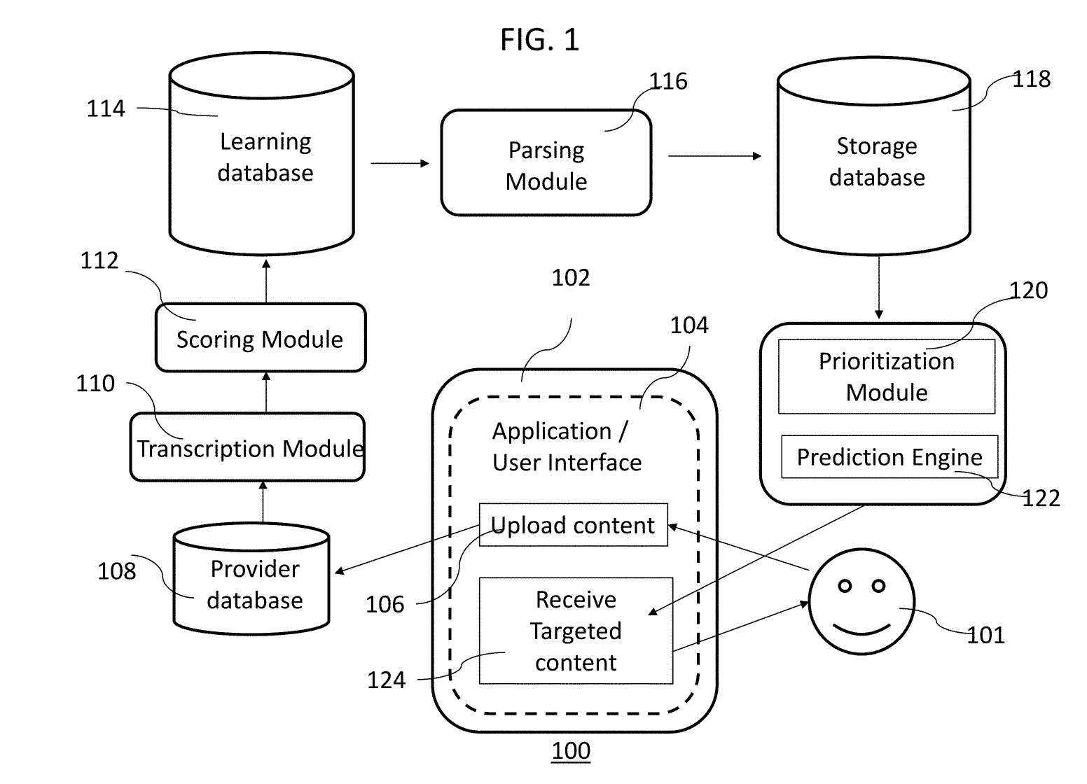

FIG. 1 shows an example system overview in which one or more embodiments of providing targeted content to a subscriber 101 using a reference subscribing account may be implemented. As depicted, configuration 100 includes, at least, a client device 102 with an instance of a client application with a user interface 104 hosted thereon, a service provider platform containing a provider database 108 that allows subscribers to upload their content 106, for example, audio recordings, video recordings, pictures, written descriptions of their experiences in the form of documents from their subscribing accounts and receive targeted content 122. In the context of the food memory example, targeted content that may be provided to the requesting subscriber's account may include, for example, a name of a food item, one or more recipes, names of stores to buy ingredients that may be used for that recipe, restaurants serving those foods, advertisements for related items, services etc., that may share at least one feature or attribute with the subscriber uploaded content and/or the subscribing account or is related to least one feature or attribute with the subscriber uploaded content and/or the subscribing account.

In at least one example embodiment, prioritization of content uploaded from one or more subscribing accounts to be provided as targeted content may be based on any of one or more content attributes associated with the subscriber content viewed from the subscribing account, a key word search, one or more attributes associated with the subscribing account, or a combination thereof.

Client device 102 may refer to a smartphone, a tablet, a personal computer or other processor-driven computing device.

Service provider platform 108 may refer to a computing framework used to deliver network-based services and/or applications. The application/interface 104 may be hosted on a client device which may be local to the subscriber 101 or may be hosted on a server which may or may not be local to the subscriber 101, and the server may be a physical server or a cloud server.

Once the subscriber content is uploaded to a service provider's database or website 108 via step 106 from the subscribing account, it is transcribed using a transcription module 110. In an embodiment, the transcription module 110 may be a commercially available tool that converts text, audio, visual or audio visual content into a computer readable text format. The scoring module 112 may then review the transcribed content for the accuracy and assign an accuracy score based on predetermined accuracy metrics to the transcribed content. For example, the scoring module may assign a higher score to the content if the content that is transcribed falls into a specific category or matches with a specific content attribute, and may assign a lower score to the content if the content that is transcribed does not fall into a specific category or match with a specific content attribute. In an embodiment, an additional or alternate review may be performed manually to assign the accuracy score based on predetermined accuracy metrics.

The system 100 may further, or alternatively, include a second transcription module including, for example, a transcription module and a machine learning engine, to transcribe any of remaining key concepts and terms missed during initial transcription of the subscriber content by the transcription module 110. In at least one embodiment, the second transcription module may include a transcription module that performs a second transcription, which may then be compared to the transcription performed by the first transcription module. Discrepancies observed between the two transcriptions may then be identified and stored in content transcription learning database for future reference. The second transcription module may thus track discrepancies during transcription by storing the missed key concepts and terms to the content transcription learning database and build a more sophisticated transcription module based on machine learning.

The transcribed and reviewed content with a certain accuracy score, for example, content with accuracy score of 99% or more, may then be stored in a database also known as learning database 114, which may continue to learn or store more information as more and more content is uploaded. The information stored in the learning database 114 may be subject to a parsing module 116 which may include a data extractor application and one or more parsers.

Parsing module 116 may extract and parse data contained in various files based on predefined categories, also known as content attributes, and organize the parsed data into internal structured data tables. The data extractor application may run a series of SQL queries for each content attribute to extract and parse data related to the subscriber uploaded content. The parsing module may be based on matching the transcribed content through a number of look up tables in a SQL database.

For example, if the word “couscous” appears in the content uploaded from a subscriber's account, the parsing module may perform a look up and determine that couscous is used in a number of countries with multiple locations, and assign further attribute values to content attribute “name of a location from where the food item originated” “or name of a place the subscriber associates with the food,” or “name of a location at which the food item was encountered to that content” and tag and/or link the uploaded content based on that content attribute too.

In another example, the content attribute “sentiment” or “emotion” may be calculated based on content relevance in addition to frequency of occurrence of a particular word within the content. The content attribute “sentiment” may be inferred from the parsed content, where parsing module looks up a sentiment table containing predefined meaningful words, and frequency of occurrence of those words and then create sentiment scores based on relevant data.

For example, the word “mother” may be present in the parsed content which is then matched to the word “mother” in the sentiment table, and based on the frequency of occurrence of that word, a sentiment score may be assigned e.g., one occurrence may receive a sentiment score of 1 whereas if it occurs more than five times, it may receive a sentiment score of 3.

In yet another example, the scoring database may include an attribute table, e.g., “tbl_sentiment”. In this attribute table, there may be already populated hierarchy of content which is classified based on varying degrees of detail. For example, family, brother and then name of the brother have increasing scores. Family is ‘1’; brother is ‘2’ and name of brother is ‘3’. The subscriber content including “my family used to eat couscous in the fall, and specifically my brother Eric would be the first to dive in to the meal” may result in a score of 6, since these words were only said once. The sentiment score (6) may then be divided by the total number of words minus the count identified words (3), resulting in 6/21 or a score of “0.29”. The higher the sentiment score, the more sentiment or emotion is attributed to that content.

Similar logic may apply to other content attributes to determine and assign a sentiment score to the content that includes a value for that attribute, for example, for content attribute “name of a location from where the food item originated” or “name of a location at which the food item was encountered to that content” if the content value is the word “Africa” then depending on the frequency of occurrence a sentiment score may be assigned to the content including the word “Africa”. This approach may enable the content to be validated first against relevant terms and then create a score based on frequency of said relevant terms.

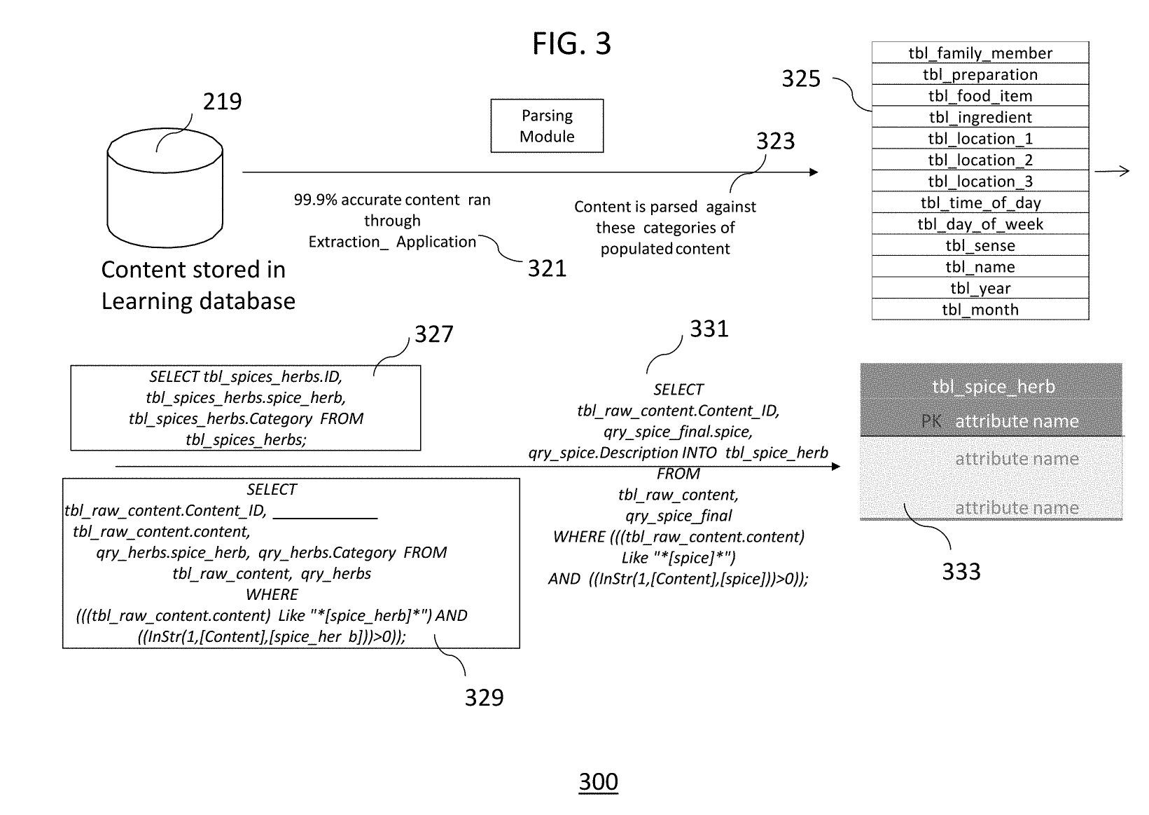

In an embodiment, the parsing module 116 may include natural language extractor and parser so as to enable extraction of meaningful data from natural language transcribed from the uploaded subscriber content. The natural language extractor and parser may take care of the ambiguity inherent in the human natural language. The structured data tables containing data extracted and parsed from the subscriber content may then be stored to a storage database 118. An example of the internal structured data table is described in detail in the description accompanying FIG. 3.

In an embodiment, the internal structured data table thus built may be linked back to the originally uploaded subscriber content through a content identifier which is assigned when the content is uploaded to the service provider database via application/user interface 104. For example, when the subscriber content including text, pictures, audio clip or video clip, is uploaded from the subscribing account, it is automatically tagged with a global unique identifier (GUID) or a content identifier which may be associated with the text, pictures, audio clip or video clip as the content is stored in the database. This identifier may be a randomly generated identifier unique to that text, picture, audio clip or video clip. The storage database may thus have e.g., a video identifier, a content identifier and transcribed content associated with the video clip. The subscriber uploaded content may be tagged by content attributes.

In an example relating to food experiences, content attributes may include any of name of a subscriber corresponding to the subscribing account, name of a relative of the subscriber, name of a food item, emotions or sentiments associated with the food item, recipe for the food item, name of an ingredient used for preparing the food item, name of a location from where the food item originated, name of a location at which the food item was encountered, time of the day at which the food item was encountered, day of the week on which the food item was eaten, year in which the food item was encountered, month in which the food item was encountered, or a combination thereof.

These content attributes may be further classified or grouped into different categories, e.g. a spice may be further classified as a pickling spice. This may be done to further provide relevant content, using look up tables that include predefined categories in the SQL database. For example, if subscriber content includes, e.g., anise seed as that subscriber's favorite spice, which is predefined as a pickling spice, it may be derived that the person likes to pickle food.

The originally uploaded subscriber content, tagged by matching content categories or content attributes and identified by the content identifier may then be used as targeted content based on the linking and tagging. This tagging associates key words or phrases with the content, which may then be used to retrieve data based on those key words and/or phrases. The targeted content may include recipes based on specific key words, suggestions for places to eat, places to visit, utensils to buy, grocery stores carrying specific produce or spices for a particular recipe, as well as other related products and services and their providers.

In at least one example embodiment, a similar process may be carried out for experiences or memories shared in other fields, for example, memories or subscriber content relating to retail experiences, in which the content attributes may include any of name of a subscriber corresponding to the subscribing account, name of a relative of the subscriber, name of a retail item, emotions or sentiments associated with the retail item, brand for the retail item, name of a raw material used for manufacturing the retail item, name of a location from where the retail item originated, name of a location at which the retail item was encountered, time of the day at which the retail item was encountered, day of the week on which the retail item was encountered, year in which the retail item was encountered, month in which the retail item was encountered, or a combination thereof.

The subscriber 101 corresponding to the subscribing account used for uploading the content may be any person, including a consumer, who is interested in sharing their memories and receiving targeted content based on their uploaded content, or a product or a service provider who is interested in providing related products and services as targeted advertising content. The subscriber may subscribe, either for a fee or for free depending on the business model, to the service corresponding to the application for providing targeted content. In accordance with some embodiments, the subscriber may or may not be required to provide identification information, e.g., name, address, phone number, email address, as well as personal information, such as personal history that informs shared memories, e.g., schools attended, places lived, places visited, preferred foods, etc. There may be different subscription levels based upon usage type for consumers, and product and/or service providers.

A recommendation engine or a prioritizing module 120 may then prioritize one or more subscriber contents uploaded from one or more subscribing accounts which is to be provided as targeted content based on any of one or more content attributes associated with the subscriber content uploaded from the reference subscribing account, a key word search, one or more attributes associated with the reference subscribing account, or a combination thereof.

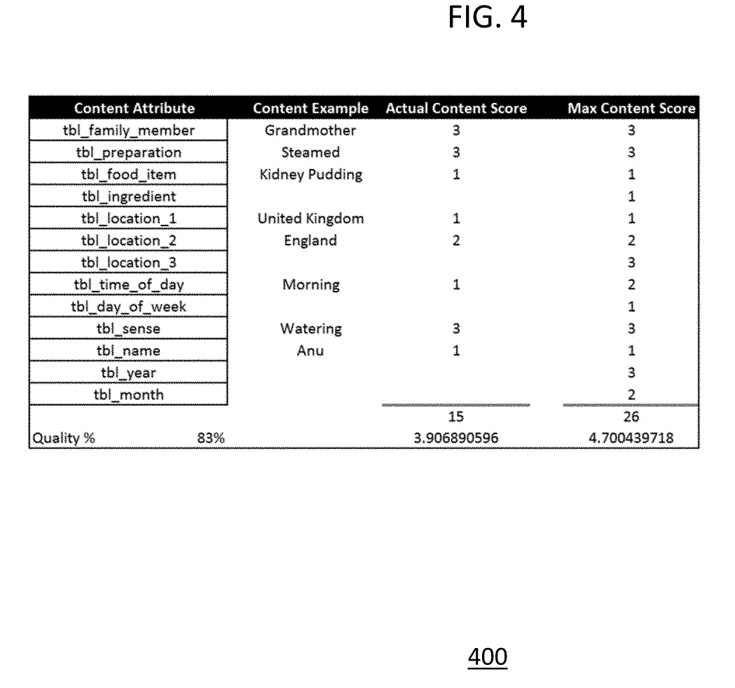

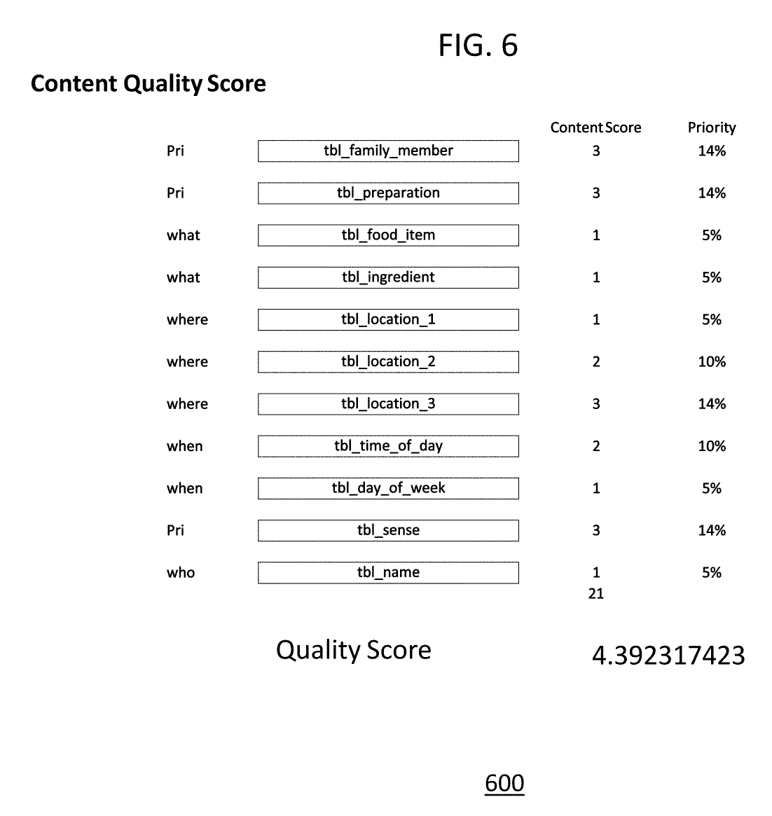

As the content is uploaded by different subscribers from different subscribing accounts, the content may be assigned a content quality score using content attributes associated with the subscriber content uploaded from the subscribing account. The content quality score is calculated by using categories or attributes of content and weighting, and by comparing calculated content quality score to a maximum quality score possible. An example of content quality score is further described in FIG. 4 and FIG. 6 and accompanying description.

In an embodiment, a subscriber 101 accesses her subscribing account and proceeds either with a key word search, or uploads a new subscriber content from the subscribing account also known as reference subscribing account using the application/user interface 104 provided by the service provider. For a key word search, the subscriber content may be retrieved as targeted content to be provided by matching key words.

However, where the subscriber uploads new content, the newly uploaded content goes through the process of transcription, accuracy check, storage, extraction and parsing as described above. The content attributes of this new subscriber uploaded content from the reference subscribing account may then be matched with the content attributes of already stored parsed, linked and tagged content uploaded by different subscribers from their respective subscribing accounts by using structured data tables. The recommendation engine or prioritizing module 120 may assign an order of priority by comparing the content quality scores of these linked and/or tagged contents uploaded by different subscribers from their respective subscribing accounts and the subscriber contents with the highest priority may be provided as targeted content first and so on.

In an embodiment, the content quality scores for one or more linked and/or tagged subscriber contents uploaded by one or more subscribers from their respective subscribing accounts may be compared to the maximum possible content quality score that may be assignable to the new subscriber uploaded content uploaded from the reference subscribing account based on which the targeted content may be provided to the reference subscribing account.

The content quality score may take into consideration presence of value for a particular attribute as well as amount of information available for that attribute. For example, for attribute “name of a location where the food item was eaten” presence of value e.g. “United States” may be assigned a score of 1 and presence of detail “Kirkland, Wash., United States” may be assigned a score of 3 based on amount of information included in the subscriber content, where the maximum possible content quality score for that attribute may be 3.

The maximum possible content quality score for the content may be calculated by assigning a maximum content quality score for each content attribute value for the newly uploaded subscriber content, taking the sum of all the values and taking log₂ of the resulting sum. The subscriber contents with higher values of content quality scores are assigned a higher priority and the ones with lower values of content quality scores are assigned a lower priority. The subscriber contents with higher priority may then be recommended as targeted content to be provided to the subscriber via subscribing account. The targeted content may be retrieved using a content identifier saved as a part of the structured data table for that content.

In at least one example embodiment, the prioritization may also include tracking the subscriber's clicks and provide additional targeted content based on what they continue to click on. In an embodiment, the subscriber's behavior may be tracked using access history of the reference subscribing account to provide additional targeted content based on that history.

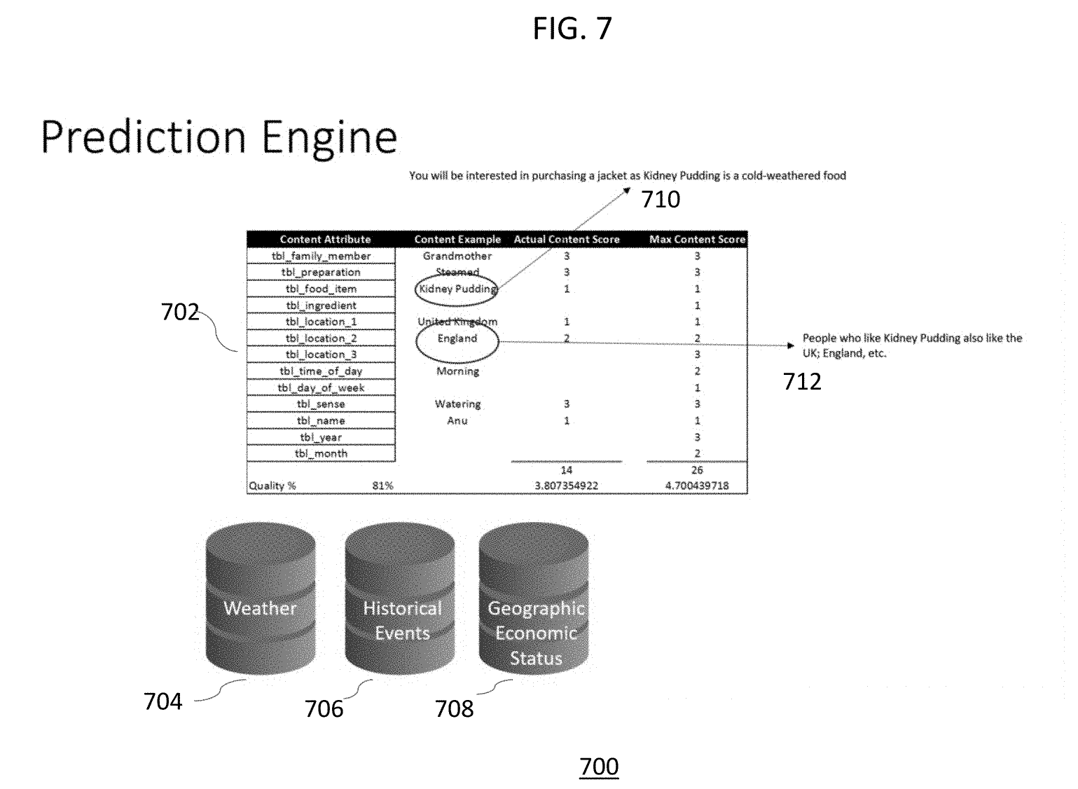

In an example embodiment, a prediction engine 122 may be used along with the recommendation engine 120 to provide targeted content to the subscriber 101. The prediction engine 122 may predict the subscriber's interests based on one or more attributes associated with the reference subscribing account including any of weather, name of a historical event, geographic location, economic status of the subscriber, or a combination thereof and is described in detail in FIG. 7 and accompanying description. The information regarding attributes associated with the reference subscribing account may be derived, e.g. geographic location may be derived from the location of the subscriber from where he accesses his subscribing account, may be linked to the other information available to the service provider, e.g. weather may be derived from the location of access and weather information available to the service provider for that location, socioeconomic status of the subscriber associated with the reference subscribing account may be derived from the picture or video of the subscriber provided in the subscriber uploaded content, or may be directly provided by the subscriber himself e.g. economic status, or may be a combination of any of the aforementioned.

In an embodiment, the content may be retrieved through a process in which a machine learning engine loads content into the database around a specific topic, e.g., food, the content may be transcribed when it is submitted to the website from a subscribing account, the application may then look at the content loaded against the transcribed content and if a match is found, a new table in the database may be populated with the GUID, and identified data.

In an embodiment, the prediction engine or prediction module 122 may predict the subscriber's interests based on one or more content attributes. When a subscriber watches content on the website or uploads content from his subscribing account e.g. a video, content attributes may be assigned to it using the process described above. The prediction engine 122 may then predict the subscriber's interest based on those content attributes, and display advertising that either shares one of the content attributes with the subscriber content or is related to the content attributes assigned to the subscriber content. For example, if a subscriber is watching a video that contains the term ‘Africa’, travel discounts for flights and trips to Africa may be displayed.

The recommendation engine or prioritizing module 120 along with the prediction engine 122 may then present the targeted content to the reference subscribing account via application/user interface 104. The recommendation engine or prioritizing module 120 and the prediction engine 122 may be implemented as parts of the storage database 118 or may be implemented as separate modules residing on the service provider's server.

Thus, FIG. 1 shows an example system overview in which one or more embodiments of providing targeted content to a reference subscribing account may be implemented.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

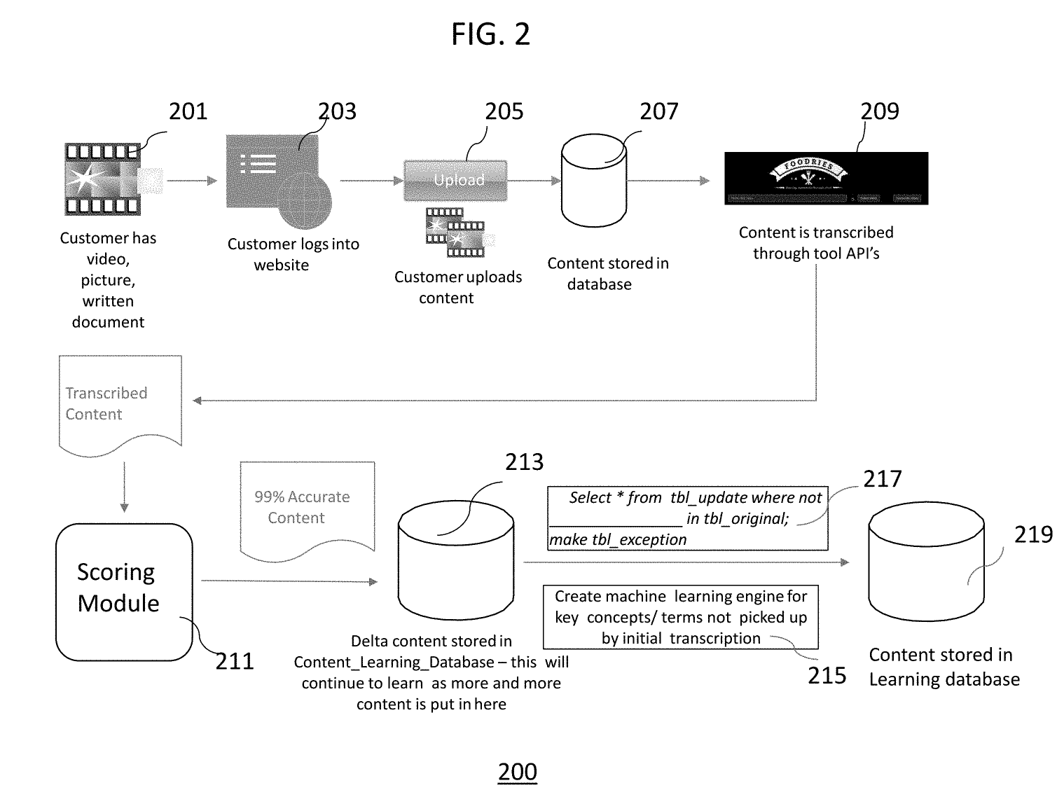

FIG. 2 shows an example processing flow of operations for implementing at least portions of providing targeted content to a reference subscribing account in accordance with various embodiments described herein. As depicted, configuration 200 includes, at least, a client device with an instance of a client application with a user interface hosted thereon, a service provider platform containing a provider database 207 that allows subscribers to upload their content 201, for example, audio recordings, video recordings, pictures, written description in the form of a document of their experiences from their subscribing accounts.

Client device may refer to a smartphone, a tablet, a personal computer or other processor-driven computing device.

Service provider platform may refer to a computing framework used to deliver network-based services and/or applications. The application/interface may be hosted on a client device which may be local to the subscriber or may be hosted on a server which may or may not be local to the subscriber, and the server may be a physical server or a cloud server.

The subscriber accesses her subscribing account on a website provided via step 203 and uploads subscriber content 201 via step 205. This uploaded subscriber content may then be stored in a database 207 and assigned a content identifier. This stored subscriber content is then transcribed using a transcription module via step 209. In an embodiment, the transcription module may be a commercially available tool that converts a document, audio, visual or audio visual content into text in a computer readable format. The reviewing tool also called as a scoring module then reviews the transcribed content for accuracy and assigns an accuracy score to the transcribed content based on predetermined accuracy metrics via step 211. The transcribed and reviewed content with the assigned accuracy score at least equal to a predetermined accuracy threshold score may then be stored in a database also known as learning database via step 213. For example, if the predetermined accuracy threshold score is 99%, then the content with accuracy score at least equal to 99% may be stored to the learning database via step 213. In an embodiment, an additional or alternate review may be performed manually to assign the accuracy score based on predetermined accuracy metrics.

The configuration 200 may further, or alternatively, include a second transcription module including, for example, a transcription tool and a machine learning engine, to transcribe via steps 215 and 217 any of remaining key concepts and terms missed during initial transcription of the subscriber content by the transcription module in step 209. In an embodiment, the second transcription module may include a transcription tool performing a second transcription, which may then be compared to the transcription performed by the first transcription module. The discrepancies observed between the two transcriptions may then be identified and stored in content transcription learning database for future reference. The second transcription module may thus keep track of discrepancies during transcription by storing the missed key concepts and terms to the content transcription learning database and build a more sophisticated transcription module based on machine learning. The transcribed and reviewed content with the assigned accuracy score at least equal to a predetermined accuracy threshold score may then be stored in a database also known as learning database via step 219, which continues to learn or store more information as more and more content is uploaded. For example, if the predetermined accuracy threshold score is 99%, then the content with accuracy score at least equal to 99% may be stored to the learning database via step 219.

FIG. 3 shows an example processing flow of operations for implementing at least portions of providing targeted content to a reference subscribing account in accordance with various embodiments described herein. The information stored in the learning database via step 213 and optionally via step 219 is then subjected to a parsing module including a data extraction application via step 321 and one or more parsers via step 323. The parsing module extracts and parses data contained in various files based on one or more content attributes or categories using look up table through a SQL database, and collects it in internal structured data table. The parsing module may include natural language extractor and parser so as to enable extraction of meaningful data from natural language transcribed from the uploaded subscriber content. The natural language extractor and parser may take care of the ambiguity inherent in the human natural language. The structured data tables containing data extracted and parsed from the subscriber content may then be stored to a storage database.

An example internal structured data table 325 as depicted illustrates different predefined categories or content attributes against which the transcribed subscriber content is parsed. The data extractor application may run a series of SQL queries for each content attribute to extract and parse data related to the subscriber uploaded content. The different categories or attributes may include any of name of a subscriber corresponding to the subscribing account, name of a relative of the subscriber, name of a food item, emotions associated with the food item, recipe for the food item, name of an ingredient used for preparing the food item, name of a location from where the food item originated, name of a location at which the food item was encountered, time of the day at which the food item was encountered, day of the week on which the food item was eaten, year in which the food item was encountered, month in which the food item was encountered, or a combination thereof. Steps 327, 329 and 331 illustrate an example “spice and herb table” 333 built and linked back to the original subscriber uploaded content using content identifier e.g. “content_id” with a primary key or PK representing the content identifier which may be a unique identifier for that specific piece of content.

FIG. 4 shows an example configuration of a database utilized for providing targeted content to a reference subscribing account may be implemented. In an exemplary embodiment, the table depicted in FIG. 4 shows the process of matching content based on actual content score and maximum content score. The content quality score depends on content attributes and weighting. A raw score may be assigned based on content attributes, the raw score may then be added to get a sum of the raw score. The calculations may further include taking log₂ of the final sum of the raw score which is then compared to a maximum quality score.

The content score per attribute may vary from 1-3 depending on the degree of detail present in the content, the more the detail, the higher the score. The maximum content score per content may vary based on the number of attributes present for that content. The actual content score is then divided by the maximum content score and multiplied by 100, the resulting % score indicates the overall quality, the higher the percentage, the better the quality of the content. For example, as shown in FIG. 4, the maximum quality score of the content is 4.70 and the actual content score 3.90, resulting in content quality score of 83%. The content is then provided as targeted content based on this content quality score, where the content with higher content quality score may be provided first and so on.

In an embodiment, the content matched with specific content attributes may be tagged by content attributes or categories by a parsing module which may include an application for tagging. After the content is transcribed, the application for tagging may perform a look up against data already populated in the learning database using various attributes or categories. Once a term is identified in the look up table, a second table may be populated with the content and the identifier for that particular category or attribute. This tagging may associate key words or phrases with the content, which may then be used to retrieve data based on those key words and/or phrases.

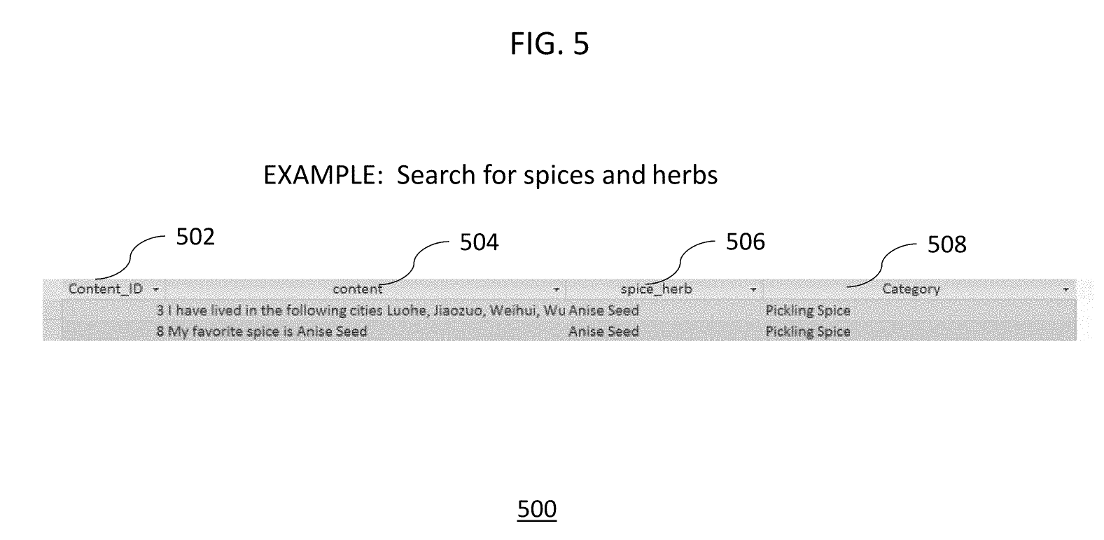

FIG. 5 shows another example configuration of a database by which at least portions of the method for providing targeted content to a reference subscribing account may be implemented in accordance with various embodiments described herein. More particularly, FIG. 5 shows an example table 500 containing a content identifier 502 linked back to the uploaded subscriber content 504, based on content attribute 506, e.g. “spice_herb”. As shown in FIG. 5, content_id “3” is assigned to the content “I have lived in the following cities Luohe, Jiaozuo . . . ” which includes a content attribute spice_herb with the value “anise seed.” These content attributes may be further classified or grouped into different categories 508, e.g. a spice may be further classified as a pickling spice. Parsing module may include an application to perform this further classification. This may be done to further provide relevant content by the application using look up tables that include predefined categories in the SQL database based on content already populated in the learning database. The data tables are then automatically updated to reflect this classification and the types data tables may depend on the type of content, e.g. for food related content there may be a spice table, for war memories there may be a war table, for skiing memories, there may be a ski resort table. For example, if subscriber content includes anise seed as that subscriber's favorite spice, which is predefined as a pickling spice, it may be derived that the person likes to pickle food and other content that shares the feature “pickling spice” may be retrieved to be provided as targeted content. The subscriber uploaded content is saved within the database linked to the structured data table including content identifier and content attribute. This saved subscriber uploaded content with content_id 3 may then be retrieved by using this linking and if all the criteria of prioritization are met as described above, may be provided as targeted content.

FIG. 6 shows an example configuration of a content quality score table by which at least portions of providing targeted content to a reference subscribing account may be implemented in accordance with various embodiments described herein. As shown in FIG. 6, the content quality score depends on content attributes and weighting. For example, a raw score may be assigned based on content attributes, the raw score is then added to get a sum of the raw score. The calculations further involve taking log₂ of the final sum of the raw score which is then compared to a maximum quality score. For example, as shown in FIG. 6, the maximum quality score of the content is 4.39. The prioritization further includes calculating priority in percent, for example, as shown in FIG. 6, for attribute “tbl_family member” the assigned content quality score is 3, which is 14% of the maximum calculated content score of 21, and hence assigned a priority score of 14%.

FIG. 7 shows an example configuration of a prediction engine by which at least portions of providing targeted content to a reference subscribing account may be implemented in accordance with various embodiments described herein. In an example embodiment, a subscriber uploads content including kidney pudding 710, or searches for the recipe for preparing kidney pudding 710 from his subscribing account. As shown in FIG. 7, if the uploaded subscriber content includes content attribute values or descriptions parsed and stored in an internal structured data table 702, for example, name of the family member: grandmother, method of preparation: steamed, location: England etc., the prediction engine 700, may consider one or more attributes associated with the subscribing account such as weather, geographic or economic status, historical events wherever applicable in addition to the content attributes to predict subscriber interest and provide additional targeted content. For example, an advertisement from a vendor selling cold weather jackets, since kidney pudding is categorized as a cold weather food, or an advertisement for flights to England, since people who like kidney pudding may also like to visit the U.K. England 712.

This further classification may be inferred from content attributes such as name of a food item, name of a location from where the food item originated, name of a location at which the food item was encountered, time of the day at which the food item was encountered, month in which the food item was encountered etc. This further classification content may be an ongoing process as more and more content is uploaded to the database by associating additional information regarding the newly uploaded content. For example, in case of experiences shared regarding a retail item, for example, shorts, the subscriber may be going to a warm weather destination. This then may result in providing that subscriber through his subscribing account a targeted content that shares at least one attribute category, for example, warm weather.

Additionally, data regarding subscribing account, e.g. weather 704, historical event 706, geographic location or economic status 708, may be derived from the location of access, time of access, date of access, month of access by the subscriber or may be provided by the subscriber himself, as described earlier in the description accompanying FIG. 1.

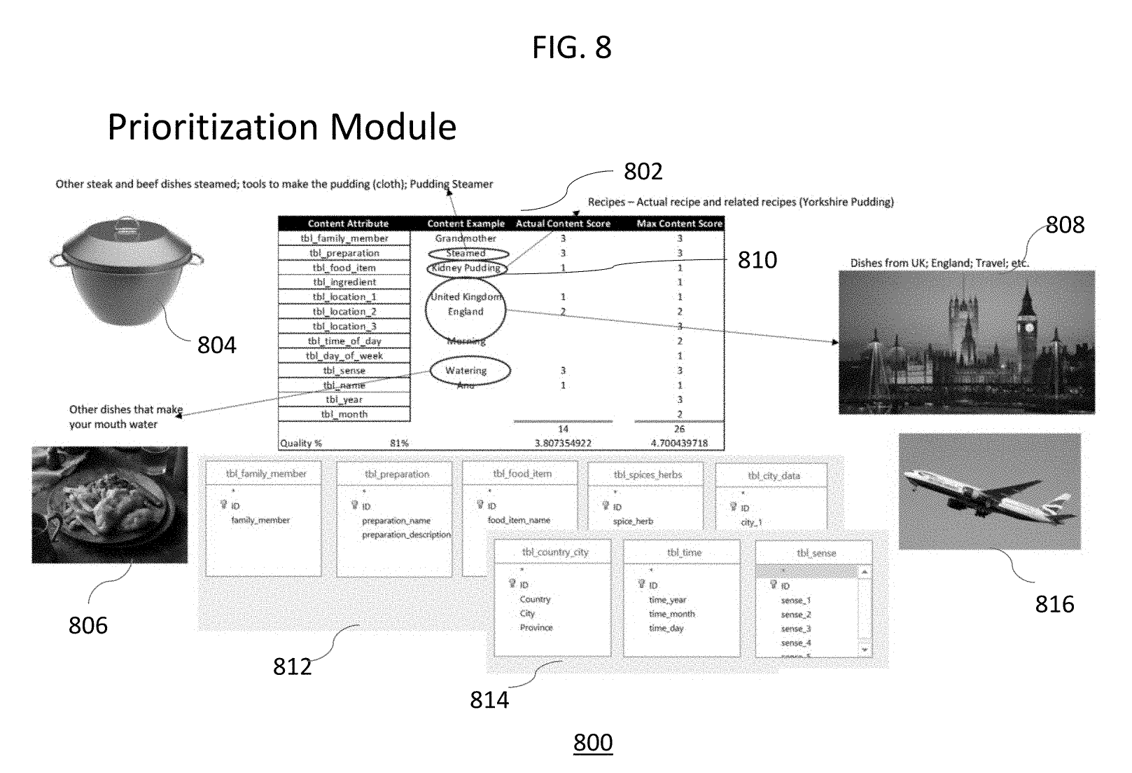

FIG. 8 shows an example configuration of a prioritizing module or a recommendation engine by which at least portions of providing targeted content to a reference subscribing account may be implemented in accordance with various embodiments described herein. In an example embodiment, as shown in FIG. 8, a subscriber uploads content including kidney pudding 810, or searches for a recipe for preparing kidney pudding 810 from his subscribing account. If the uploaded subscriber content includes content attribute values or descriptions parsed and stored in an internal structured data table 802 as shown, for example, name of the family member: grandmother, method of preparation: steamed, name of a location at which the food item was encountered or name of a location from where the food item originated: England etc., the prioritizing module or recommendation engine 800, may consider content attributes associated with that content, for example, any one or more of name of a subscriber associated with the subscribing account, name of a relative of the subscriber, name of a food item, emotions associated with the food item, recipe for the food item, name of an ingredient used for preparing the food item, name of a location from where the food item originated, name of a location at which the food item was encountered, time of the day at which the food item was encountered, day of the week on which the food item was eaten, year in which the food item was encountered, month in which the food item was encountered, to assign order of priority to the contents uploaded by one or more subscribers and stored in the storage database as described in the description accompanying FIG. 6. The stored subscriber contents with matching content attributes and hence high content quality scores and higher order of priority, stored in the storage database, may then be retrieved by using structured data tables 812 and 814 and using content_id stored in the structured data tables 812 and 814 which is linked to the stored subscriber uploaded content.

Additionally, the prioritizing module 800 may recommend related content to be provided as targeted content, for example, recipes for other steak or beef dishes that are steamed, dishes that are prepared by grandmother, or related dishes such as Yorkshire pudding, which are different from kidney pudding but related to kidney pudding as it may share one or more content attribute values or descriptions of the kidney pudding, e.g. name of a location from where the food item originated or name of a location at which the food item was encountered: England, name of an ingredient used for preparing the food item: beef, at which the food item was encountered: morning etc.

In an embodiment, the recommendation engine or prioritizing module 800 may work in concert with the prediction engine described above in the description accompanying FIG. 1 and FIG. 7, which may consider one or more attributes associated with the subscribing account such as weather, geographic or economic status, historical events wherever applicable in addition to the content attributes to predict subscriber interest and provide additional targeted content. For example, an advertisement from a vendor selling cold weather jackets, utensils used to make steamed pudding 804, other dishes that make the subscriber's mouth water 806, other dishes from the same place 808, restaurants that sell those other dishes, airline ticket providers to the United Kingdom 816 etc.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

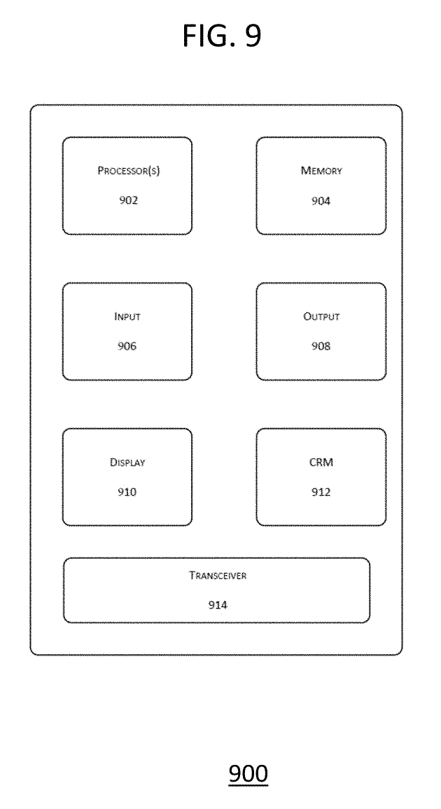

FIG. 9 shows a block diagram illustrating an example computing device for executing at least part of providing targeted content to a reference subscribing account in accordance with various embodiments described herein.

More particularly, FIG. 9 shows an illustrative computing embodiment, in which any of the processes and sub-processes for providing targeted content to a subscribing account may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 900 may typically include, at least, one or more processors 902, a system memory 904, one or more input components 906, one or more output components 908, a display component 910, a computer-readable medium 912, and a transceiver 914.

Processor 902 may refer to, e.g., a microprocessor, a microcontroller, a digital signal processor, or any combination thereof.

Memory 904 may refer to, e.g., a volatile memory, non-volatile memory, or any combination thereof. Memory 904 may store, therein, an operating system, an application, and/or program data. That is, memory 904 may store executable instructions to implement any of the functions or operations described above and, therefore, memory 904 may be regarded as a computer-readable medium.

Input component 906 may refer to a built-in or communicatively coupled keyboard, touch screen, or telecommunication device. Alternatively, input component 906 may include a microphone that is configured, in cooperation with a voice-recognition program that may be stored in memory 904, to receive voice commands from a user of computing device 900. Further, input component 906, if not built-in to computing device 900, may be communicatively coupled thereto via short-range communication protocols including, but not limited to, radio frequency or Bluetooth.

Output component 908 may refer to a component or module, built-in or removable from computing device 900 that is configured to output commands and data to an external device.

Display component 910 may refer to, e.g., a solid state display that may have touch input capabilities. That is, display component 910 may include capabilities that may be shared with or replace those of input component 906.

Computer-readable medium 912 may refer to a separable machine readable medium that is configured to store one or more programs that embody any of the functions or operations described above. That is, computer-readable medium 912, which may be received into or otherwise connected to a drive component of computing device 900, may store executable instructions to implement any of the functions or operations described above. These instructions may be complimentary or otherwise independent of those stored by memory 904.

Transceiver 914 may refer to a network communication link for computing device 900, configured as a wired network or direct-wired connection. Alternatively, transceiver 914 may be configured as a wireless connection, e.g., radio frequency (RF), infrared, Bluetooth, and other wireless protocols.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods and apparatuses, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. An apparatus for providing targeted content to a reference subscribing account, comprising:
a processor, comprising:
a transcription module to transcribe subscriber content uploaded from the reference subscribing account,
a scoring module to:
assign an accuracy score to the transcribed subscriber content for accuracy based on predetermined accuracy metrics, and
store, to a learning database, the transcribed subscriber content when the assigned accuracy score at least equals a predetermined accuracy threshold score;
a parsing module to extract and parse the stored subscriber content from the learning database based on one or more content attributes, and
a prioritizing module to prioritize one or more subscriber contents uploaded from one or more subscribing accounts to be provided as targeted content based on any of: one or more content attributes associated with the subscriber content uploaded from the reference subscribing account, a key word search, one or more attributes associated with the reference subscribing account, or a combination thereof; and
a user interface to provide the prioritized targeted content to the reference subscribing account.

2. The apparatus of claim 1, wherein the subscriber content includes any of text content, audio content, visual content, audiovisual content, or a combination thereof.

3. The apparatus of claim 1, wherein the learning database further comprises a second transcription module to transcribe any of remaining key concepts and terms missed by the transcription module.

4. The apparatus of claim 1, wherein the one or more content attributes comprise any of a name of a subscriber corresponding to the subscribing account, name of a relative of the subscriber, name of a food item, emotions associated with the food item, recipe for the food item, name of an ingredient used for preparing the food item, name of a location from where the food item originated, name of a location at which the food item was encountered, time of the day at which the food item was encountered, day of the week on which the food item was eaten, year in which the food item was encountered, month in which the food item was encountered, or a combination thereof.

5. The apparatus of claim 1, wherein the prioritizing module assigns order of priority for one or more subscriber contents uploaded from the one or more subscribing accounts by comparing calculated content quality score for the one or more subscriber contents to a highest possible quality score, wherein the content quality score is calculated using content attributes and weighting.

6. The apparatus of claim 1, wherein the one or more attributes associated with the reference subscribing account comprise any of: weather, name of a historical event, geographic location, economic status of the subscriber, or a combination thereof; and
wherein the one or more attributes associated with the reference subscribing account are derived from any of: subscriber uploaded content from the reference subscribing account, information related to the reference subscribing account, location of access of the reference subscribing account, time and date of access of the reference subscribing account, or a combination thereof, are provided by the subscriber, or a combination thereof.

7. The apparatus of claim 1, wherein the user interface comprises a web based user interface or a mobile based user interface.

8. A computer-implemented method for providing targeted content to a reference subscribing account comprising:
transcribing subscriber content uploaded from the reference subscribing account,
assigning an accuracy score to the transcribed subscriber content for accuracy based on predetermined accuracy metrics,
storing the subscriber content to a learning database when the assigned accuracy score at least equals a predetermined accuracy threshold score,
extracting and parsing the stored subscriber content from the learning database based on one or more content attributes,
prioritizing one or more subscriber contents uploaded from one or more subscribing accounts to be provided as targeted content based on any of: one or more content attributes associated with the subscriber content uploaded from the reference subscribing account, a key word search, one or more attributes associated with the reference subscribing account, or a combination thereof; and
providing the targeted content in the order of priority to the subscribing account.

9. The method of claim 8, wherein the subscriber content includes any of, text content, audio content, visual content, audiovisual content, or a combination thereof.

10. The method of claim 8, further comprising second transcribing any of remaining key concepts and terms missed during the transcribing.

11. The method of claim 8, wherein the one or more content attributes comprise any of name of a subscriber corresponding to the subscribing account, name of a relative of the subscriber, name of a food item, name of an emotion associated with the food item, recipe for the food item, name of an ingredient used for preparing the food item, name of a location where the food item originated, name of a location where the food item was eaten, time of the day when the food item was eaten, day of the week when the food item was eaten, year when the food item was eaten, month when the food item was eaten, or a combination thereof.

12. The method of claim 8, wherein the prioritizing one or more subscriber contents uploaded from one or more subscribing accounts includes comparing calculated content quality score for one or more subscriber contents to a maximum quality score possible, wherein the content quality score is calculated using content attributes and weighting.

13. The method of claim 8, wherein the one or more attributes associated with the reference subscribing account comprise any of: weather, name of a historical event, geographic location, economic status of the subscriber, or a combination thereof; and
wherein the one or more attributes associated with the reference subscribing account are derived from any of: subscriber uploaded content from the reference subscribing account, information related to the reference subscribing account, location of access of the reference subscribing account, time and date of access of the reference subscribing account, or a combination thereof, are provided by the subscriber, or a combination thereof.

14. The method of claim 8, wherein providing targeted content in order of priority to the reference subscribing account is accomplished by using a web application or a mobile application.

15. A non-transitory computer-readable medium having executable instructions stored therein that, when executed, cause one or more processors corresponding to an apparatus having a learning database and a user interface to perform operations comprising:
transcribing subscriber content uploaded from a reference subscribing account,
assigning an accuracy score to the transcribed subscriber content for accuracy based on predetermined accuracy metrics,
storing the subscriber content to the learning database when the assigned accuracy score at least equals a predetermined accuracy threshold score,
extracting and parsing the stored subscriber content from the learning database based on one or more content attributes,
prioritizing one or more subscriber contents uploaded from one or more subscribing accounts to be provided as targeted content based on any of one or more content attributes associated with the subscriber content uploaded from the reference subscribing account, a key word search, one or more attributes associated with the reference subscribing account, or a combination thereof; and
providing the targeted content in the order of priority to the subscribing account.

16. The computer program product of claim 15, wherein the subscriber content comprises any of text content, audio content, visual content, audiovisual content, or a combination thereof.

17. The computer program product of claim 15, further comprising instructions for transcribing any of remaining key concepts and terms missed during the transcribing.

18. The computer program product of claim 15, wherein the one or more content attributes comprise any of name of a subscriber corresponding to the subscribing account, name of a relative of the subscriber, name of a food item, name of an emotion associated with the food item, recipe for the food item, name of an ingredient used for preparing the food item, name of a location where the food item originated, name of a location where the food item was eaten, time of the day when the food item was eaten, day of the week when the food item was eaten, year when the food item was eaten, month when the food item was eaten, or a combination thereof.

19. The computer program product of claim 15, wherein the instructions for prioritizing one or more subscriber contents uploaded from one or more subscribing accounts include instructions for:
comparing calculated content quality score for one or more subscriber contents to a maximum quality score possible, wherein the content quality score is calculated using content attributes and weighting.

20. The computer program product of claim 15, wherein the one or more attributes associated with the reference subscribing account comprise any of weather, name of: a historical event, geographic location, economic status of the subscriber, or a combination thereof; and
wherein the one or more attributes associated with the reference subscribing account are derived from any of: subscriber uploaded content, information related to the subscribing account, location of access of the subscribing account, time and date of access of the subscribing account, or a combination thereof, are provided by the subscriber, or a combination thereof.

21. The computer program product of claim 15, wherein providing targeted content in order of priority to the reference subscribing account is accomplished by using a web application or a mobile application.
